(19) United States
(12) Patent Application Publication
(10) Pub. No.: US 2025/0074749 A1
(43) Pub. Date: Mar. 6, 2025

(54) METHOD FOR PAYLOAD MONITORING OF A CRANE COMPRISING TWO LOAD SUSPENSION MEANS

(71) Applicant: Liebherr-Werk Nenzing GmbH, Nenzing (AT)

(72) Inventor: Walter MIETSCHNIG, Brand (AT)

(21) Appl. No.: 18/794,899

(22) Filed: Aug. 5, 2024

(30) Foreign Application Priority Data
Aug. 28, 2023 (DE) 10 2023 123 025.5

(51) Int. Cl. B66C 13/16; B66C 13/48; G01L 5/00

(52) U.S. Cl. CPC B66C 13/16; B66C 13/48; G01L 5/0071

(57) ABSTRACT

The disclosure relates to a method, a crane, and a computer programme product for payload monitoring of a crane, comprising a boom and two load suspension means for lifting one joint or different loads, wherein a first load suspension means carries a load which is introduced into the boom at a first load location, and a second load suspension means carries a load which is introduced into the boom at a second load location that is spaced apart from the first load location. According to the disclosure, first and second loads currently introduced into the boom at the first and at the second load location are detected.

### CROSS REFERENCE TO RELATED APPLICATION

The present application claims priority to German Patent Application No. 10 2023 123 025.5 filed on Aug. 28, 2023. The entire contents of the above-listed application are hereby incorporated by reference for all purposes.

### TECHNICAL FIELD

The present disclosure relates to a method for payload monitoring of a crane, a crane, and a computer programme product.

### BACKGROUND

For lifting and moving very heavy loads, it is known to fasten these simultaneously to a plurality of cranes and to move them in a coordinated tandem or multiple crane lift. However, in particular types of crane it is also possible to lift loads simultaneously via two hoist ropes of one single crane. Two-hook operation of this kind makes it possible, in addition to lifting and moving a joint load, to also lift and move two different loads by means of one single crane.

### SUMMARY

A typical application for lifting or moving a joint load in two-hook operation is rotating and turning of objects or loads when these are transported in another location from where they must later be used and mounted in their installation position. Then, the load must be lifted as far as possible without diagonal pull, and rotated in the air. If no further crane is available on the construction sited, or only limited space is available, said controlled rotation of the load can take place using a single crane in two-hook operation.

An example for a crane type that allows for such two-hook operation are mobile cranes comprising a tiltable main boom and a luffing jib mounted thereon. The main boom has a boom head, over which a hoist rope is guided. The luffing jib is pivotably fastened to the boom head, which jib also has a boom head, over which a further hoist rope is guided. The main boom is typically guyed via a guy block or via a derrick boom, and is tiltable about its tilt axis, while the luffing jib is guyed via its own guy means and is pivotable.

The regions on the boom, i.e. in the example described above the points on the main boom and on the luffing jib at which the hoist ropes (or in general the load suspension means) are connected to the boom and which introduce the load, acting in each case, into the boom structure, are referred to in the following as load locations. The current load, introduced into the boom at the corresponding load location by a hoist rope, results on the one hand from the lifted load fastened to the hoist rope (this may be an individual load or, in the case of a jointly raised object, a partial load received by the respective hoist rope), and on the other hand the dead load of the hoist rope (wherein the latter is ignored for the following considerations).

In the case of cranes having a single hoist rope (one-hook operation), payload monitoring or load torque limitation is used as standard, which is intended to prevent tilting of the crane or damage to the crane components. In this case, the payload monitoring typically compares a currently received load, in a particular crane position, with a corresponding limit value (permissible payload), which is frequently taken from a payload table stored in the controller, or in some cases is calculated dynamically using a model. If the current load reaches or exceeds the permissible payload, then the crane movement is typically stopped. A corresponding warning can already be output to the crane driver before the permissible payload is reached.

The problem or particular feature in two-hook operation is that a given load at one load location influences the maximally permissible payload at another load location, and vice versa. If a payload utilisation at one load location increases, for example due to a change in the radius (load radius) or due to a shift in the centre of gravity, the maximally permissible payload at the other load location must be reduced. Therefore, conventional payload monitoring or load torque limitation therefore cannot be used in the case of two-hook operation.

For this reason, in conventional crane operation (one-hook operation), loads may be lifted only by one of the load suspension means, i.e. only at one of the load locations. The other load suspension means or the other load location may not be loaded in this case. Only in this way is sufficiently precise load display and payload utilisation display or monitoring achieved.

For two-hook operation, there is currently still no safe method that is monitored by the control computer. If nonetheless a joint load or two individual loads is/are lifted using both hooks at both load locations, then this is typically performed under the personal responsibility of the crane driver or any monitoring device on the crane. Therefore, the operating instructions of the cranes either prohibit two-hook operation, or at most only hints are provided as to how the procedure should take place.

The object of the present disclosure is therefore that of allowing a payload-monitored two-hook operation in cranes.

According to the disclosure, this object is achieved by a method and system as described herein.

According thereto, a method for payload monitoring of a crane is proposed. The crane monitored by means of the method according to the disclosure comprises a boom, which can in particular be a tiltable boom. The crane further comprises two load suspension means for lifting and moving one joint load or two individual loads (two-hook operation). The load suspension means can in particular each comprise a hoist rope and a load hook, wherein other fastening means such as lugs or a crossbar can also be provided.

In monitored two-hook operation, each of the two load suspension means can carry a load and introduce it into a boom. The load of the first load suspension means is introduced into the boom at a first load location, while the load of the second load suspension means is introduced into the boom at a second load location that is spaced apart from the first load location. The introduced loads can be partial loads of a load lifted together or an object lifted together, or the loads of individually lifted loads or objects. (As already mentioned, the dead loads of the load suspension means also contribute to the introduced loads, but this is not mentioned again explicitly in the following).

Since the two load locations are spatially spaced apart from one another, and in particular are associated with different load radii, optionally different permissible payload ranges or maximally permissible payloads are applicable for them. In order to take this into account in the payload monitoring, it is provided according to the disclosure that a first load currently introduced into the boom at the first load location is detected, and a second load currently introduced into the boom at the second load location is detected. The detection can take place for example via corresponding sensors in guy ropes of the boom and/or in different boom heads of the boom. An example load sensor may be a piezoelectric sensor or another type of load sensor. The detected loads form the basis of the payload monitoring according to the disclosure, or are transmitted to the executing control unit.

The payload monitoring according to the disclosure is based on a calculation method which is based on a series of load location-related variables. These are defined in a special coordinate system in which the two load locations are specified along a first axis (e.g. the abscissa), and in which a second axis (e.g. the ordinate) orthogonal to the first axis represents the load. In this case, the two load locations are defined by two mutually spaced points or regions on the first axis. In this case, in particular the distance selected between the two load locations in their representation along the first axis is irrelevant, since this distance in particular does not matter. It can be selected arbitrarily, in order to appropriately simplify the calculation (for example the distance can be set to be equal to one and/or can be unitless).

In this coordinate system, a first defined correlation between a maximum (i.e. maximally permissible) payload at the first load location and a maximally still permissible payload at the second load location in the case of maximum payload utilisation at the first load location, is defined. The latter will also be referred to in the following as “remaining maximum payload”. Thus, a generally maximally permissible payload is specified for the first load location, which payload may not be exceeded, independently of the payload utilisation at the second load location. If the current load at the first load location corresponds to said maximum payload (=maximum payload utilisation), then the payload at the second load location may not exceed a defined remaining maximum payload.

In the mentioned coordinate system, furthermore a second defined correlation between a maximum (i.e. maximally permissible) payload at the second load location and a maximally still permissible payload at the first load location (again referred to in the following as “remaining maximum payload”) in the case of maximum payload utilisation at the second load location, is defined. The above statements relating to the remaining maximum payload at the second load location apply correspondingly.

Furthermore, a first intersection point is defined, at which the first and second defined correlations are fulfilled simultaneously. In particular, the defined correlations represent functional correlations (in the simplest case linear correlations) in the coordinate system, which intersect at the first intersection point in the coordinate system. In the simplest case, the functional correlations can be defined merely by two points in the coordinate system (e.g. a maximally permissible payload at one load location, and the remaining maximum payload at the other load location).

The mentioned variables defined in the coordinate system may have been calculated or specified in advance and stored in a control unit or in a data memory, including in memory of the control unit, for example in the form of tables for different boom positions, crane configurations, etc. Further, instructions may be stored in the control unity memory for carrying out the methods as described herein. For this purpose, for example known payload tables for one-hook operation can be used. Alternatively, it can be provided that the mentioned variables are calculated, in the context of the method according to the disclosure, by a control unit, for example depending on a current boom position. Thus, in the case of a pivotable luffing jib, the maximum payload at the first load location depends on the pivot angle of said jib, since this defines the load radius, and smaller payloads are permissible in the case of larger load radii.

According to the disclosure, a third defined correlation between the detected first load and the detected second load is determined in the defined coordinate system. This is in particular a functional correlation in the mentioned coordinate system (in the simplest case a linear correlation, which can in turn be specified only by two points in the coordinate system-specifically the two detected loads).

Furthermore, a second intersection point is determined, at which the third defined correlation and the first intersection point have the same value along the first axis. In other words, it is an intersection point of the third defined correlation with a vertical line on the first axis, through the first intersection point. In an orientation where the first axis is the abscissa, the second intersection point is thus located below, above or on the first intersection point.

According to the disclosure, the positions of the first intersection point and of the determined second intersection point along the second axis (i.e. their load values) are compared with one another. If the load value of the second intersection point is greater than the load value of the first intersection point, then the crane is in an inadmissible payload range and a corresponding measure is automatically taken.

The measure may include issuing a warning, for example an acoustic and/or optical warning to the crane driver, that an inadmissible payload range has been reached in the current two-crane operation. Alternatively or in addition, there may be automatic intervention in a current movement of the crane by a control unit, in particular stopping of the current crane movement or performing a countermovement or compensating movement, which brings the crane back into the permissible payload range, in which the load value of the second intersection point is smaller than or equal to the load value of the first intersection point. The control unit may be a crane controller or a separate control unit.

The method according to the disclosure can be implemented on a conventional load torque limitation, which can be supplied with the detected first and second loads and which either determines the above-mentioned variables, defined in the coordinate system (maximum payload values, remaining maximum payload values, first intersection point) itself (e.g. from corresponding stored payload tables or via a model which takes into account in particular the current crane configuration and position), or also is supplied these as input variables.

The mentioned first, second and third defined correlations may be mathematical relations taking into account the respective payload values, in particular in the form of functions which intersect or contain the respective payload values in the coordinate system.

Since the first axis contains the two load locations and is in particular dimensionless, the spacing of the load locations on the first axis, or the intermediate values, in particular do not matter. Therefore, above all the load values (i.e. the values on the second axis) at the two load locations, and in particular at the intersection points, are relevant for the calculation method according to the disclosure.

The calculation method according to the disclosure is based on the finding that the payloads at the two load locations can be considered an overall system, i.e. a load combination, wherein different load combinations can be converted into one another by corresponding mathematical transformations.

A first extreme load combination results for the event that the payload at the second load location is fully utilised (i.e. the effective load corresponds to the maximum payload at the second load location). This is associated with a specific remaining maximum payload at the first load location. This can have a value of greater than zero or zero (i.e. no load may act at the first load location or be raised by means of the first load suspension means), in particular if the first load location corresponds to a larger load radius than the second load location. A second extreme load combination results for the event that the payload at the first load location is fully utilised (i.e. the effective load corresponds to the maximum payload at the first load location). This is associated with a specific remaining maximum payload at the second load location. This can have a value of zero or greater than zero (i.e. a certain load may still act at the second load location or be raised by means of the second load suspension means), in particular if the first load location corresponds to a larger load radius than the second load location.

Limit values for the payloads at the first and second load locations (i.e. current maximum payloads) can be determined on the basis of the first intersection point, which values are between the mentioned extreme positions. These correspond to a current load combination, in which a maximum payload utilisation is not present either at the first or at the second load location.

The second intersection point, determined from the detected loads currently acting at the two load locations, provides information on whether the current load combination corresponds to a permissible load combination which is between the two above-mentioned extreme load combinations. Furthermore, a comparison of the intersection points allows for a statement to be made regarding the overall payload utilisation of the crane in the case of the current load combination.

This allows for payload monitoring or load torque limitation in two-hook operation, which ensures that the decisive, jointly acting, payload limits of the overall system are adhered to, or that corresponding measures are taken when an inadmissible payload range is reached. This allows for safe, continuously monitored two-hook operation.

Furthermore, the current loads and the payload limits that are decisive for the current overall load situation or load combination can optionally be displayed, for example on a display unit in a crane driver's cab of the crane.

The payload monitoring based on the load values of the first and second intersection points is optionally carried out in addition to monitoring of the individual loads of the respective load locations. In other words, in addition the detected first load exceeding the current maximum payload at the first load location, and the detected second load exceeding the current maximum payload at the second load location is optionally monitored by comparing the values of the first and second intersection point, and corresponding measures are taken when the maximum payload is exceeded.

Optionally, a predictive calculation in the event of assumed continuation of a current crane movement can be performed. For example, the above-mentioned, defined variables (maximum payloads, remaining maximum payloads, first intersection point) can change in the case of a movement of the boom and/or of a load suspension means. As a result, the ratio or the spacing between the first and the second intersection point also changes. Furthermore, the first and/or the second load can also change in the case of a movement of the boom and/or of a load suspension means, which in turn results in a change of the second intersection point. A predictive calculation in the case of an assumed continued movement of the boom and/or of a load suspension means makes it possible for a measure to be taken early, for example a warning to be output and/or a crane movement to be braked or stopped, before an inadmissible payload range is reached.

In a possible embodiment it is provided that the maximally permissible payload at the first load location, i.e. the remaining maximum payload at the first load location, in the case of maximum payload utilisation at the second load location, is zero. Thus, if the maximum payload at the second load location is reached, no more load may be suspended at the first load location. Optionally, the remaining maximum payload at the second load location is greater than zero, i.e. even if the full payload is utilised at the first load location, a load may nonetheless still be suspended at the second load location. The behaviour described above results e.g. in the case of a crane having a tiltable main boom which comprises a boom head having a hoist rope and the second load location, and a needle point which is mounted on the main boom and comprises a boom head having a further hoist rope and the first load location. Since the first load location is at a greater distance from the articulation point of the main boom or has a greater load radius, the maximum payload is smaller at the first load location than at the second load location.

In a further possible embodiment it is provided that the first, second and third defined correlations are linear correlations. This simplifies the calculation method according to the disclosure, since the first and second intersection points result in particular from intersecting straight lines in the mentioned coordinate system.

In this case, the straight lines are each defined by two points (the straight connecting lines represent the respective extreme load combinations, wherein the respective maximum and remaining maximum payloads of a load combination represent two points which mathematically clearly specify the respective straight connecting lines) and do not necessarily have to be present in the control unit as actual functions. It is alternatively possible, however, to define the straight lines as a function of the value along the first axes, and to assign specific values of the first axis (e.g. zero and one) for the two load locations. As already mentioned, the spacing of the load locations along the first axis does not have any impact on the load values of the intersection points. Nonetheless, the intersection points can have specific values on the first axis, and the straight lines can also be defined as functions of the value of the first axis.

This results in particular in the following simplifications:

The first linear correlation represents a first straight connecting line between the maximum payload at the first load location and the remaining maximum payload at the second load location in the mentioned coordinate system. Analogously thereto, the second linear correlation represents a second straight connecting line between the maximum payload at the second load location and the remaining maximum payload at the first load location.

In this case, the third linear correlation corresponds to a third straight connecting line between the detected first load and the detected second load. Said current load combination is thus represented by the third straight connecting line which is clearly specified by the two detected loads (as two points in the coordinate system).

Thus, the first intersection point results from the intersection point of the first and second straight connecting lines in the coordinate system. The second intersection point is an intersection point of the third straight connecting line with a vertical line which is positioned on the first axis and extends through the first intersection point.

Although these correlations have been explained on the basis of straight connecting lines and their intersection points, these are of course represented by corresponding mathematical correlations. In particular, corresponding equations exist for the load values of the first and second intersection points, which equations contain the maximum payloads and the remaining maximum payloads at the first and second load location.

It is thus also clear that the spacing of the two load locations on the first axis in the coordinate system is not included in the calculation and can be set as desired (as long as it is greater than zero), since this spacing does not influence the load values of the intersection points and the maximum payloads.

In a further possible embodiment it is provided that, for a lift of a joint load, a maximum payload is defined both for the first load location and also for the second load location, which both correspond to the load value of the first intersection point. This is based on the finding that the defined correlations (which in the simplest case represent straight connecting lines) in the case of maximum joint payload utilisation (i.e. viewed in isolation the maximum payload is not utilised in full either at the first or at the second load location, but in combination the full joint payload is reached, and therefore the load may not be raised at either load location without reducing the load at the other load location) always extend through the first intersection point.

In the case of linear correlations, the load combination with maximum joint payload utilisation (=maximally permissible load combinations) can be considered “tilting compensators”, in the case of which the maximum payloads at the two load locations for the maximally permissible load combinations, i.e. the corresponding straight connecting lines, “tilt” about the first intersection point. Therefore, there must be a load combination having maximum joint payload utilisation, in which the straight connecting line extending through the first intersection point extends in parallel with the first axis. In this situation, the maximum payloads at both load locations (=currently permissible payloads) are of the same size and correspond to the load value (i.e. the value on the second axis) of the first intersection point. Thus, in the case of identical utilisation at both load locations, the jointly valid, currently permissible payload can be read out directly from the load value of the first intersection point, which can serve for example as an entry into the corresponding payload table for the two-hook operation.

If the first detected load or the second detected load is greater than said jointly valid, currently permissible payload, then there is an inadmissible payload range and a corresponding measure is taken. The measure can include outputting a warning and/or automatic intervention in a current movement of the crane by the control unit, as has already been explained above.

In a further possible embodiment, it is provided that the first load is determined by acquisition of a first force in a first guy rope of the boom and the second load is determined by acquisition of a second force in a second guy rope of the boom, wherein the first and second forces may be acquired via sensors arranged on the first and second guy ropes, and transmitted to the control unit. The first guy rope may be a guying of an adjustable luffing jib, which can include a cable adjustment, in order to tilt the luffing jib up and down. The second guy rope may for example be a guying of a tiltable main boom, which can include a cable adjustment, in order to tilt the main boom up and down.

In a further possible embodiment, it is provided that a currently permissible payload at the first load location and a currently permissible payload at the second load location are calculated from the first intersection point and the determined second intersection point, if the load value of the second intersection point is smaller than the load value of the first intersection point. These determined currently permissible payloads represent payload limit values for the current load combination or load distribution. If these payload limit values are exceeded, i.e. if the detected first load exceeds the currently permissible payload, determined in each case from the intersection points, at the respective load location, then a measure is taken automatically, which may include outputting a warning and/or automatic intervention in a current movement of the crane by the control unit, as has already been explained above.

In a further possible embodiment, it is provided that the mentioned currently permissible payloads at the first and at the second load location are determined in that the load values of the first load and of the second load are in each case added to the difference of the load values of the first and second intersection points. As a result, for the current load situation in two-hook operation, the payload limits valid for the current load distribution can be reliably determined, and monitored for being exceeded.

The spacing of the second intersection point from the first intersection point along the second axis, i.e. the load difference between the two intersection points, is in particular a measure for the total payload utilisation by the current load combination. In particular, the ratio of the load values can represent a percentage payload utilisation. It is thus not a question, here, of the individual utilisation of the loads at the individual load locations, but rather the total, i.e. combined, payload utilisation, which considers the total load situation at the two load locations.

In a further possible embodiment, it is provided that a measure is automatically taken if the first load is greater than the maximum payload at the first load location, or if the second load is greater than the maximum payload at the second load location, wherein the measure optionally includes outputting a warning and/or intervention in a current movement of the crane by the control unit, as described above. Thus, in addition to monitoring the adherence to the payload limits currently valid for the current load combination on the basis of the two intersection points, there is also individual payload monitoring of the respective acting loads at the two load locations. This can take place for example in a conventional manner, as in the case of one-hook operation, on the basis of corresponding payload tables.

In other words, it is ensured that even if the load value of the second intersection point is smaller than or equal to the load value of the first intersection point, the maximum payload at the first load location or the maximum payload at the second load location is still not exceeded by the first or second load.

In a further possible embodiment, the crane is configured such that the first load location is movable relative to the second load location, in particular by movement of a sub-boom that includes the first load location (e.g. an adjustable luffing jib) relative to a main boom that includes the second load location.

Alternatively or in addition, the first and second load locations can be at a constant distance from one another along the boom (which is the case for example for a luffing jib mounted on a main boom, since the respective boom heads have the same spacing, irrespective of the pivot angle of the luffing jib or of the tilt angle of the main boom).

In a further possible embodiment, it is provided that the boom comprises a main boom which is mounted on a carrier device of the crane so as to be pivotable about a horizontal tilt axis and comprises a second boom head and a boom tip which is fastened to the main boom in a rigid manner or so as to be pivotable about a horizontal pivot axis and comprises a first boom head, wherein the first load suspension means is guided over the first boom head, and the second load suspension means is guided over the second boom head. The first load location is thus located on the first boom head, and the second load location is located on the second boom head. The boom may be a lattice boom. This can be guyed via a guy block or via a derrick boom. The carrier device an comprise a rotatable upper structure, on which the main boom is articulated, wherein the upper structure can be rotatably mounted on a mobile undercarriage.

In a further possible embodiment, it is provided that the first load suspension means is adjustable by means of a first hoisting winch and the second load suspension means is adjustable by means of a second hoisting winch, wherein the hoisting winches are controllable by means of a control unit of the crane. The control unit may be the control unit that performs the calculation according to the disclosure, or a separate control unit. The two load suspension means are optionally adjustable independently of one another.

In a further possible embodiment, it is provided that a deviation of the first load suspension means and/or of the second load suspension means from the vertical is acquired and, in the case of an identified deviation, a warning is output and/or a command prompt is displayed and/or a countermeasure is taken automatically by the control unit. Thus, in addition to the payload monitoring according to the disclosure, in two-hook operation diagonal pull monitoring is implemented for the two load suspension means, which monitoring may be carried out by the same control unit (wherein of course it is also possible that a plurality of separate control units may be provided). The mentioned countermeasure can optionally comprise a movement stop or a movement of the boom (for example of a main boom and/or of a luffing jib that is adjustable relative to the main boom) that compensates the deviation.

In this case, in particular both the deviation to the front/back (i.e. in parallel with the tilt plane) and the deviation to the right/left (i.e. laterally or perpendicularly to the tilt plane) is measured and analysed. If a deviation from the vertical is identified, then a diagonal pull of the considered load suspension means is present (wherein usually either neither load suspension means or both load suspension means have a diagonal pull), which should be compensated. For this purpose, at least one actuator (e.g. a hydraulic cylinder or a cable winch of an adjustable guy cabling), which actuates the boom or a sub-boom of the boom, is controlled by the control unit in such a way that the deviation from the vertical is compensated. The compensation of the deviation from the vertical can be able to be initiated by an input by the crane driver (for example after a command prompt has taken place) or in a fully automatic manner by the control unit.

Since, as already mentioned, generally a diagonal pull of one load suspension means is associated with a corresponding diagonal pull of the other load suspension means, in the simplest case it is sufficient to monitor the diagonal pull of just one of the two load suspension means. Of course, the diagonal pulls of both load suspension means can also be monitored.

Correspondingly, the crane may comprises at least one measuring device for detecting a deviation of the first or second load suspension means from the vertical. Two measuring devices can be provided, for detecting the diagonal pull of both load suspension means.

The disclosure furthermore relates to a crane comprising a boom, comprising two load suspension means for lifting a joint load or different individual loads, wherein a first load suspension means, adjustable by means of a first hoisting winch, is connected to the boom at a first load location, and a second load suspension means, adjustable by a second hoisting winch, is connected to the boom at a second load location that is spaced apart from the first load location, and comprising a detection device, by means of which a first load introduced into the boom at the first load location, and a second load introduced into the boom at the second load location, can be detected.

According to the disclosure, the crane comprises a control unit which is configured to carry out the method according to the disclosure (i.e. the above-described steps which relate to the control unit or can be carried out by said unit). In this case, the same properties and advantages result for the method according to the disclosure, and therefore a repeated description is dispensed with. In particular, all the modifications and optional embodiments described above for the method according to the disclosure also apply for the crane according to the disclosure, in any desired combination.

The disclosure furthermore relates to a corresponding computer programme product for carrying out the method according to the disclosure, comprising commands which, when the programme is executed, cause the steps of the above-described method (in any desired embodiment) relating to the control unit to be carried out by the control unit of the crane according to the disclosure. Optionally, the computer programme product can be operated on conventional crane controllers or load torque limitations, such that retrofitting of hardware components is not required. In this case, conventional load torque limitations can be incorporated, as mentioned above.

### BRIEF DESCRIPTION OF THE FIGURES

Further features, details and advantages of the disclosure will emerge from the following embodiments which are explained with reference to the drawings, in which:

FIG. 1: is an overall side view of an embodiment of the crane according to the disclosure, comprising a load that is lifted jointly in two-hook operation;

FIG. 2-5: show, by way of example, the coordinate system and the variables defined therein for the payload monitoring according to the disclosure;

FIG. 6: is an overall side view of the crane according to FIG. 1 in a situation with diagonal pull; and

FIG. 7: is an enlarged view of the first boom head of the crane according to the disclosure, comprising a measuring device for determining the verticality of a load suspension means according to an embodiment.

### DETAILED DESCRIPTION

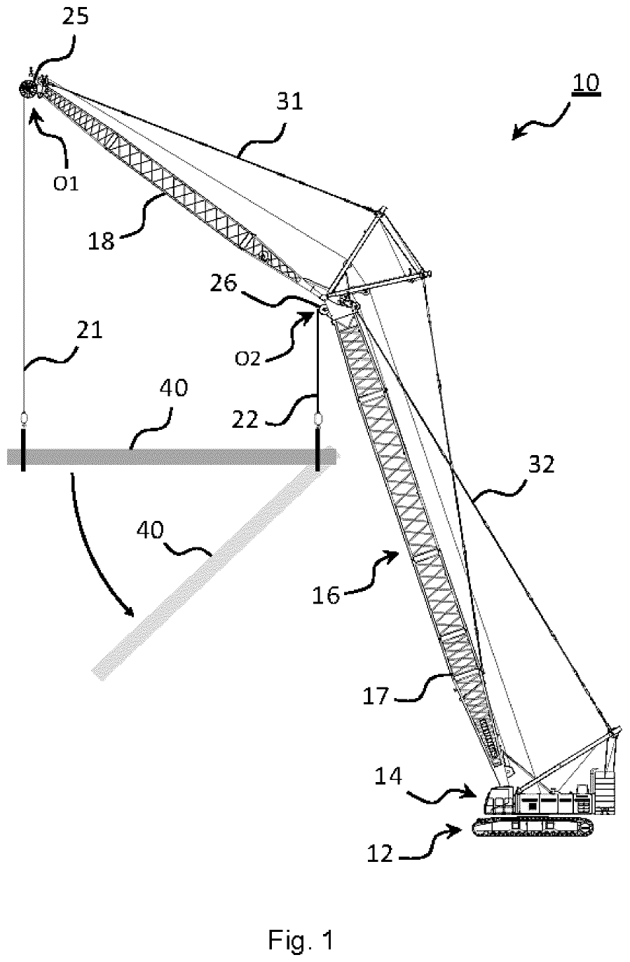

FIGS. 1, 6, and 7 are drawn approximately to scale, although other relative sizing may be used. FIG. 1 is an overall side view showing an embodiment of the crane 10 according to the disclosure. The crane 10 is a mobile lattice mast crane which comprises an undercarriage 12 having a crawler chassis, and an upper structure 14 that is mounted on the undercarriage 12 so as to be rotatable about a vertical axis of rotation. Of course, other embodiments are also conceivable here, for example an undercarriage having a wheeled or rail chassis, or a stationary crane comprising a boom that is pivotably mounted on a tower or a column.

In the embodiment shown here, the crane 10 comprises a boom 16 which comprises a main boom 17 that is pivotally mounted on the upper structure 14 so as to be tiltable about a horizontal tilt axis, and a boom tip in the form of a luffing jib 18 which is mounted on the main boom 17 and is pivotable relative to the main boom 17 about a horizontal pivot axis.

The crane 10 has two load suspension means 21, 22 which, in the embodiment shown, each comprise a hoist rope and a load hook fastened thereon. The luffing jib 18 has a first boom head 25, over which the hoist rope of a first load suspension means 21 is guided. Via the first load suspension means 21, a first load L1 is introduced into the boom 16 at a first load location O1 on the first boom head 25. The main boom 17 has a second boom head 26, over which the hoist rope of a second load suspension means 22 is guided. Via the second load suspension means 22, a second load L2 is introduced into the boom 16 at a second load location O2 on the second boom head 26.

The luffing jib 18 is guyed via a first guy rope 31, wherein the first guy rope 31 comprises an adjustable guy cabling in particular between two guy blocks of the luffing jib 18, via which cabling the luffing jib 18 can be pivoted relative to the main boom 17. The hoist rope of the first load suspension means 21 is mounted such that it can be wound onto and unwound from a first hoisting winch. The main boom 17 is guyed via a second guy rope 32, wherein in particular an adjustable guy cabling is arranged between a guy block articulated on the upper structure 14 and the upper structure 14, via which cabling the main boom 17 can be tilted up and down relative to the upper structure 14, about the tilt axis. The hoist rope of the second load suspension means 22 is mounted such that it can be wound onto and unwound from a second hoisting winch. The two hoisting winches are optionally controlled by a control unit of the crane 10, wherein the load suspension means 21, 22 are in particular adjustable independently of one another.

In the case of the embodiment shown in FIG. 1, a joint load 40 is fastened to the two load suspension means 21, 22. As indicated by the curved arrow, the load 40 can be moved, e.g. rotated, by corresponding adjustment of the load suspension means 21, 22. In the case of a jointly raised load 40 a load distribution over the two load suspension means 21, 22 results, such that a particular partial load L1, L2 is introduced at each load location O1, O2.

In the case of two-hook operation, the two load suspension means 21, 22 are operated simultaneously with load at the two different load locations O1, O2. The particular feature of the two-hook operation is that a given load at the first load location O1 influences the maximally permissible payload at the second load location O2, and vice versa. If a payload utilisation at one load location O1, O2 increases, for example due to a change in the radius or due to a shift in the centre of gravity, then the maximally permissible payload at the other load location O2, O1 must be reduced.

This is explained on the basis of the following example: If the maximum load (e.g. 40 t) is present e.g. at the first load location O1, then the second load location O2 may be loaded with an associated minimum load (remaining maximum payload). If the first load location O1 is completely unloaded (0 t), the load at the second load location O2 may rise to the maximally permissible payload, i.e. to the maximum load at the second load location O2 (e.g. 100 t).

The payload monitoring according to the disclosure now provides a calculation method for determining the jointly acting, currently permissible payloads for the individual load locations O1, O2. These can be used for monitoring the crane operation, but optionally also for displaying the current loads and permissible payload utilisations and the permissible loads on a display unit (e.g. a crane monitor). This applies irrespective of the exact embodiment of the crane 10. The calculation method will now be explained on the basis of a specific embodiment, wherein the concept according to the disclosure is also independent of the exact configuration of the crane 10.

The calculation is based on the conventional crane-payload values, i.e. the maximum payloads L1ₘₐₓ and L2ₘₐₓ at the first load location O1 and at the second load location O2. These can for example be stored in corresponding payload tables, and change depending on the current boom position. Furthermore, it is assumed in the following embodiment that, in the case of a maximum payload utilisation of the luffing jib 18 (first load location O1), the main boom 17 (second load location O2) may structurally still receive a load, while in the case of a maximum payload utilisation of the main boom 17, the luffing jib 18 (or the second load location O2) may not receive any more load. In other words, in the case of maximum payload utilisation at the second load location O2, the maximally still permissible payload L1ᵥ at the first load location O1 (=remaining maximum payload L1ᵥ) is zero, while in the case of maximum payload utilisation at the first load location O1, the maximally still permissible payload L2ᵥ at the second load location O2 (=remaining maximum payload L2ᵥ) has a value greater than zero, in particular depending on the current boom position.

In the present case, the mentioned values are continuously adjusted to the current crane position, in particular boom position, and can be taken or interpolated from corresponding payload tables, as may be known for example from conventional one-hook operation.

In order to now determine the jointly valid payload limits for two-hook operation, i.e. for a particular currently lifted load combination (which can result from a jointly lifted load 40 or from two lifted individual loads), the mentioned payload limits are jointed to extreme load combinations and defined in a coordinate system which contains the two load locations O1 and O2 at different positions of a first axis and the associated load values along a second axis that is orthogonal to the first axis.

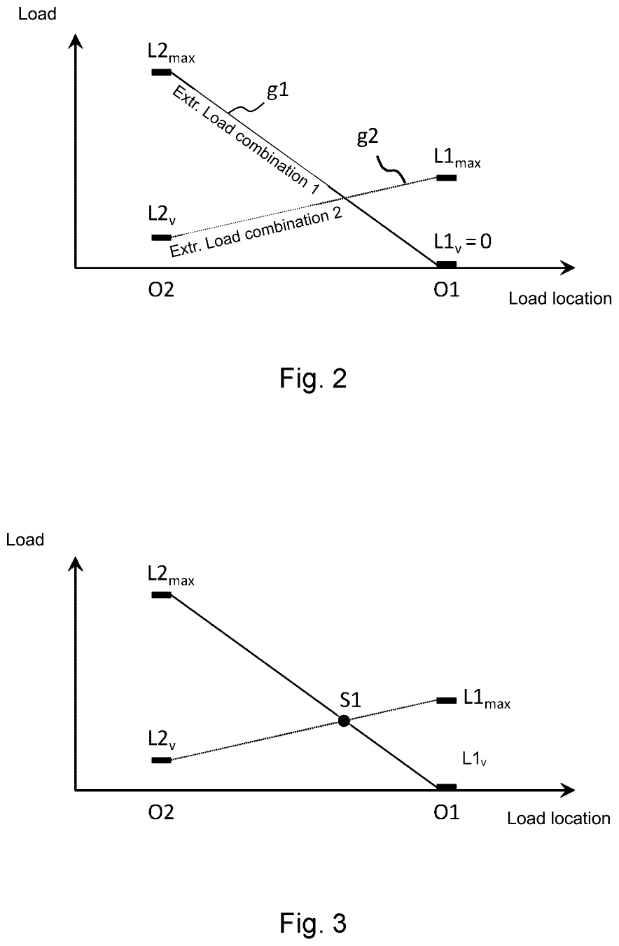

FIG. 2-5 show an example of a coordinate system of this kind, wherein the first axis forms the abscissa (X-axis) and the second axis forms the ordinate (Y-axis). The load locations O1, O2 are spaced apart from one another along the abscissa, wherein the spacing can be selected as desired since it is in any case not important, in particular for the calculation.

In FIG. 2, for the second load location O2 the maximum payload L2ₘₐₓ (=payload limit value isolated for the second load location O2), and for the first load location O1 the maximum payload L1ₘₐₓ (=payload limit value isolated for the second load location O1), are plotted separately, wherein in the present case the maximum payload L1ₘₐₓ of the first load location O1 is smaller than the maximum payload L2ₘₐₓ of the second load location O2. Furthermore, the remaining maximum payload L2ᵥ at the second load location O2 is plotted. Since the remaining maximum payload L1ᵥ at the first load location O1 is zero in this embodiment, this is positioned on the abscissa.

These values are now combined, by defined correlations, to extreme load combinations (see FIG. 2: extr. load combination 1: L2ₘₐₓ with L1ᵥ=0; extr. load combination 2: L1ₘₐₓ with L2ᵥ), wherein these are linear correlations in the embodiment considered here. For this purpose, the respective load values of the extreme load combinations are connected to one another by means of straight connecting lines g1 and g2 (see FIG. 2: extr. load combination 1: L2ₘₐₓ connected to L1ᵥ=0 via a first straight connecting line g1; extr. load combination 2: L1ₘₐₓ connected to L2ᵥ via a second straight connecting line g2).

These straight connecting lines g1, g2 of the two extreme load combinations intersect at a first intersection point S1, as can be seen from FIG. 3. In this case, the y-value or load value L_{S1} of the first intersection point S1 is located both between L1ₘₐₓ and L1ᵥ=0 and also between L2ₘₐₓ and L2ᵥ. The load value L_{S1} of the first intersection point S1 depends on each of the four payload limit values L1ₘₐₓ, L1ᵥ, L2ₘₐₓ and L2ᵥ and amounts, in the embodiment considered here, to:

$${L}_{S 1} = \frac{L {1}_{max} . L {2}_{max}}{L {1}_{max} + L {2}_{max} - L {2}_{v}} .$$

It is apparent that L_{S1} does not depend on the spacing of the first and second load locations O1, O2 along the abscissa (this is selected as desired in FIG. 2-5).

It follows from this consideration that the maximally permissible load combinations between their two extremes (extr. load combination 1 and 2 according to FIG. 3) behave as a compensator with a pivot point in the first intersection point S1.

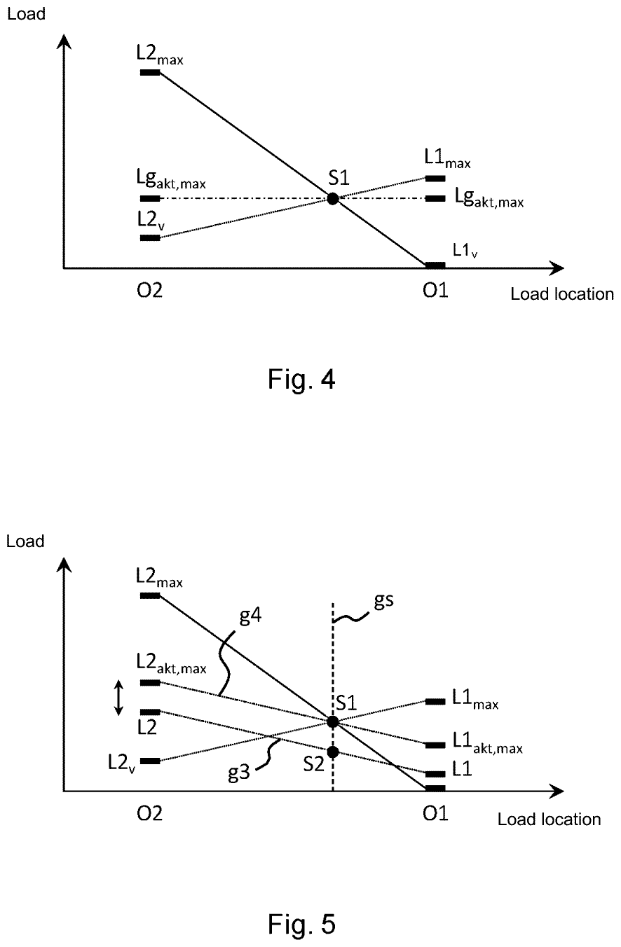

A special maximally permissible load combination can be derived directly from this, which is shown in FIG. 4 by a dot-dashed straight connecting line. Since each maximally permissible load combination has a straight connecting line between jointly valid, currently permissible payloads, which line extends through the first intersection point S1, the maximally permissible load combination with a straight connecting line extending in parallel with the abscissa corresponds precisely to the case of uniformly distributed load. The associated jointly valid, currently permissible payloads Lg_{akt,max} thus have identical values and may not be exceeded jointly.

Thus, the relevant payload limit value, i.e. the jointly valid, currently permissible payload Lg_{akt,max} for the joint load lift having a central centre of gravity can be determined directly from the load value L_{S1} of the first intersection point S1. Said payload limit value Lg_{akt,max} can be used as an entry for a payload table for the two-hook operation.

For example, in the event of different individual loads being lifted via the two load suspension means 21, 22, or in the event of an off-centre mass centre or diagonal pull being present in the case of a jointly raised load 40, the loads L1 and L2 acting on the two load locations O1 and O2 are of different sizes. If a current load combination of this kind (i.e. the currently acting loads L1 and L2 and a third straight connecting line g3 connecting said loads L1, L2) is viewed in the coordinate system (cf. FIG. 5), then a second intersection point S2 of said third straight connecting line g3 results, having a straight line gs that is positioned perpendicularly on the abscissa and extends through the first intersection point S1.

The payload monitoring according to the disclosure now defines an inadmissible payload range in that the load value L_{S2} of the second intersection point S2 is greater than the load value L_{S1} of the first intersection point S1. If, in contrast, the load value L_{S2} of the second intersection point S2 is smaller than (or equal to) the load value L_{S1} of the first intersection point S1 (cf. FIG. 5), then the current load combination is in the permissible payload range (provided that neither of the current loads L1 and L2 exceeds their associated payload limit value L1ₘₐₓ and L2ₘₐₓ).

For the current load combination (FIG. 5), the total payload utilisation A_{Kran} of the crane results from the ratio of the load values L_{S1} and L_{S2} of the first and second intersection points S1, S2:

$${A}_{Kran} = \frac{{L}_{S 2}}{{L}_{S 1}} .$$

The currently permissible payloads L1_{akt,max} and L2_{akt,max}, valid for the current load combination, at the first and second load location O1, O2, can be calculated from the difference of the load values L_{S1} and L_{S2} of the first and second intersection points S1, S2 by a linear displacement of the current load values L1, L2 along the ordinate by said difference (see double-headed arrow in FIG. 5):

$$L {1}_{akt , max} = L 1 + ( {L}_{S 1} - {L}_{S 2} ) , \\ L {2}_{akt , max} = L 2 + ( {L}_{S 1} - {L}_{S 2} ) .$$

The fourth straight connecting line g4 of the calculated maximally permissible load combination, obtained from the shift by the amount (L_{S1}−L_{S2}) proceeding from g3, now extends through the first intersection point S1.

It can also be seen on the basis of FIG. 5 why the additional monitoring criterion L_{S2}≤L_{S1} is necessary in two-hook operation. If one were to focus only on the individual maximum payloads L1ₘₐₓ, L2ₘₐₓ at the respective load locations O1, O2, an inadmissible payload range at the current load combination shown in FIG. 5 would not be identified. Even in the borderline case (maximally permissible load combination with straight connecting line g4), the jointly valid limit values L1_{akt,max} and L2_{akt,max} are far below the respective maximum payloads L1ₘₐₓ and L2ₘₐₓ valid individually for the load locations O1, O2. The actual payload situation in two-hook operation, in which the two loads L1 and L2 mutually influence one another, is taken into account by the criterion L_{S2}≤L_{S1}.

Optionally, however, in addition to monitoring the criterion L_{S2}≤L_{S1}, the individual payload utilisations at the respective load location are also monitored, i.e. L1≤L1ₘₐₓ and L2≤L2ₘₐₓ.

If one of these criteria is infringed (i.e. if L_{S2}>L_{S1} or L1>L1ₘₐₓ or L2>L2ₘₐₓ), then a countermeasure is taken automatically. For example, a warning can be output to the crane driver on a display unit, and/or an automatic movement stop can be performed.

It is noted that, irrespective of the specific embodiment, alternatively reaching the respective limit can already trigger the measure.

Optionally, the current load situation and the valid limit values and/or the current total payload utilisation A_{Kran} is displayed to the crane driver on a display unit, optionally displayed graphically. The display can take place analogously to FIG. 2-5, i.e. a graphical display of the position of the current loads L1, L2, the respective limit values L1ₘₐₓ, L2ₘₐₓ, L2ᵥ, and the corresponding straight connecting lines g1, g2, g3 and the two intersection points S1 and S2. Alternatively or in addition, the respective load values and/or the total payload utilisation A_{Kran} can be displayed digitally.

The loads L1 and L2 currently acting on the two load locations O1, O2 are detected by a detection device and transmitted to the controller. This can be achieved for example by sensors for detecting the forces in the first and second guy ropes 31, 32.

The graphs of the straight connecting lines g1, g2, g3, g4 and of the coordinate system shown in FIG. 2-5 serve merely to illustrate the calculation method according to the disclosure. The latter is based on mathematical equations and relationships in which the various mentioned variables are included. Therefore it is not essential for example for an actual straight connecting line g1, g2, g3, g4 to be defined or to be given as a function, in the control unit.

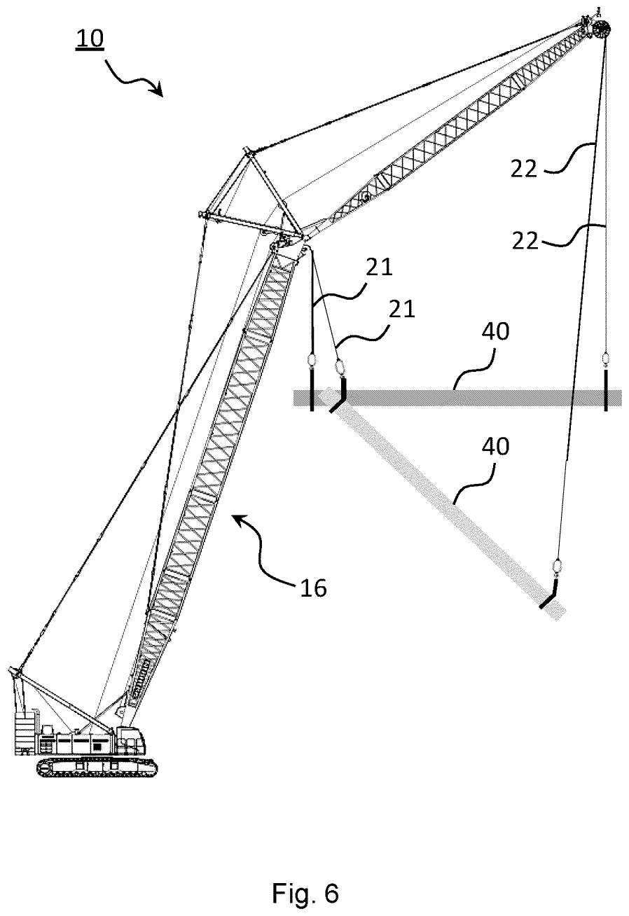

When a joint load is lifted using two hooks at different load locations, furthermore a diagonal pull is to be anticipated, above all in the case of a rotation of a jointly raised load, which has to be detected ad taken into account in the payload utilisation. A situation of this kind is shown in FIG. 6, wherein the load suspension means 22 have a diagonal pull “inwards” and the load suspension means 21 have a diagonal pull “outwards”.

A diagonal pull of this kind impacts on the load displays, the payload monitoring, the control cable, and the supporting structure of the crane 10 or of the boom 16. Since the payload monitoring of the crane 10 in particular proceeds form a vertically suspended load (without diagonal pull), the control unit calculates an incorrect load L1, L2 from the force measured by the detection device, in particular too low a current load L1, L2 if, for determining the forces, the sensors are arranged in the guy ropes. When diagonal pull occurs, the actual load L1, L2 is always higher towards the inside, and may not be ignored since it has an influence on the actual structural loading of the boom 16.

In order to ensure safety in two-hook operation with a joint load, a measurement or determination of the diagonal pull angle of the load suspension means 21 and/or 22 is required. With knowledge of the diagonal pull angle, the actual load L1, L2 and the payload utilisation A_{Kran} of the crane 10 can be calculated exactly and displayed to the crane driver for example.

Optionally, the diagonal pull monitoring is implemented by a corresponding assistance system in the crane 10, which system can be autonomous or part of the payload monitoring according to the disclosure.

In one embodiment of the diagonal pull monitoring system, the diagonal pull of the hoist rope of at least one load suspension means 21, 22 is forward/back and to the side is displayed and if applicable corrected. The crane driver can thus identify and prevent lateral and front pull. It is optionally displayed to the crane driver on a display unit, e.g. on the crane display, whether the hoist rope or the hoist ropes is/are in the vertical position (e.g. in the form of a plan view on the respective load location O1, O2 on the boom 16). If there is a diagonal pull, it can be provided that, in the event of actuation by the crane driver (e.g. via an input button on the master switch), the crane 10 automatically corrects the diagonal pull by compensating movements of the boom 16 (e.g. of the first and/or second hoisting winch). Alternatively, a correction can be able to be performed automatically (i.e. without intervention by the crane driver) by the control unit.

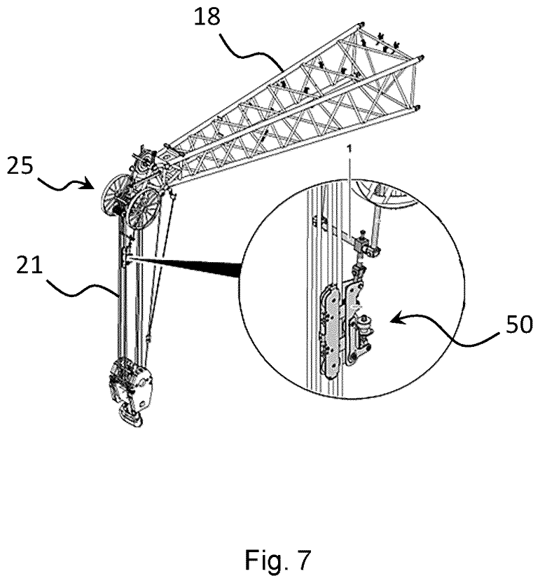

FIG. 7 shows an embodiment for a sensor means 50 for detecting the diagonal pull of the hoist rope of the first load suspension means 21. The first boom head 25 of the luffing jib 18 is visible, comprising a deflection roller over which the hoist rope is guided. One of the reevings of the hoist rope is connected to a measuring device 50 fastened to the first boom head 25, which measuring device detects the deviation of the hoist rope from the vertical towards the side (i.e. to the left/right) and in parallel with the tilt plane (i.e. to the front/back), and forwards this to the control unit. Alternative detection devices are of course conceivable. Optionally, a second sensor means 50 can be provided on the second load suspension means 22 or on the second boom head 26.

### LIST OF REFERENCE SIGNS

10 crane
12 undercarriage
14 upper structure
16 boom
17 main boom
18 boom tip
21 first load suspension means
22 second load suspension means
25 first boom head
26 second boom head
31 first guy rope
32 second guy rope
40 received load
50 sensor means for diagonal pull detection
g1 first straight connecting line
g2 second straight connecting line
g3 third straight connecting line
g4 fourth straight connecting line
L1 first detected load
L2 second detected load
L1_{akt,max} currently permissible payload at the first load location
L2_{akt,max} currently permissible payload at the second load location
Lg_{akt,max} jointly valid, currently permissible payload
L1ₘₐₓ maximum payload at the first load location
L2ₘₐₓ maximum payload at the second load location
L1ᵥ remaining maximum payload)
L2ᵥ remaining maximum payload)
O1 first load location
O2 second load location
S1 first intersection point
S2 second intersection point

1. Method for payload monitoring of a crane, wherein the crane comprises a boom and two load suspension means for lifting one joint load or different individual loads, wherein a first load suspension means carries a load which is introduced into the boom at a first load location, wherein a second load suspension means carries a load which is introduced into the boom at a second load location that is spaced apart from the first load location,
wherein a first load currently introduced into the boom at the first load location, and a second load currently introduced into the boom at the second load location, is detected;
a coordinate system, in which along a first axis two mutually spaced points represent the first and second load locations and in which a second axis perpendicular to the first axis represents a load at the respective load location, wherein the following variables are defined:
a first defined correlation between a maximum payload at the first load location and a maximally permissible payload at the second load location in the case of maximum payload utilisation at the first load location,
a second defined correlation between a maximum payload at the second load location and a maximally permissible payload at the first load location in the case of maximum payload utilisation at the second load location, and
a first intersection point, at which the first and second defined correlations are fulfilled simultaneously;
a third defined correlation between the first load and the second load is determined in the defined coordinate system;
a second intersection point is determined, at which the third defined correlation and the first intersection point have the same value along the first axis; and
a measure is automatically taken if, along the second axis, the value of the second intersection point is greater than the value of the first intersection point.

2. Method according to claim 1, wherein the maximally permissible payload at the first load location in the case of a maximum payload utilisation at the second load location is zero, and/or the maximally permissible payload at the second load location in the case of a maximum payload utilisation at the first load location is zero.

3. Method according to claim 1, wherein the first, second and third defined correlations are linear correlations, wherein
the first linear correlation is a first straight connecting line between the maximum payload at the second load location and the maximally permissible payload at the first load location in the case of maximum payload utilisation at the second load location,
the second linear correlation is a second straight connecting line between the maximum payload at the first load location and the maximally permissible payload at the first second load location in the case of maximum payload utilisation at the first load location,
the third linear correlation is a third straight connecting line between the first load and the second load,
the first intersection point is an intersection point of the first and second straight connecting lines, and
the second intersection point is an intersection point of the third straight connecting line with a vertical line on the first axis through the first intersection point.

4. Method according to claim 1, wherein for a lift of a joint load a maximum payload for the first and second load location is defined, which corresponds to the value of the first intersection point along the second axis, wherein a measure is automatically taken if the first detected load or the second detected load is greater than this maximum payload.

5. Method according to claim 1, wherein the first load is determined by acquisition of a first force in a first guy rope of the boom and the second load is determined by acquisition of a second force in a second guy rope of the boom.

6. Method according to claim 1, wherein a currently permissible payload at the first load location and a currently permissible payload at the second load location are determined from the first intersection point and the determined second intersection point, if, along the second axis, the value of the second intersection point is smaller than the value of the first intersection point, wherein a measure is automatically taken if the first load is greater than the currently permissible payload at the first load location, or if the second load is greater than the currently permissible payload at the second load location.

7. Method according to claim 6, wherein the currently permissible payload at the first load location is determined by adding the first load and the difference between the first and second intersection points along the second axis, and the currently permissible payload at the second load location is determined by adding the second load and the difference between the first and second intersection points along the second axis.

8. Method according to claim 1, wherein a measure is automatically taken if the first load is greater than the maximum payload at the first load location, or if the second load is greater than the maximum payload at the second load location.

9. Method according to claim 1, wherein the first load location is movable relative to the second load location, by moving a sub-boom, comprising the first load location, relative to a main boom of the crane, comprising the second load location, and/or wherein the first and second load locations are at a constant distance from one another along the boom.

10. Method according to claim 1, wherein the boom comprises a main boom which is mounted on a carrier device, a rotatable upper structure, of the crane so as to be pivotable about a horizontal tilt axis and comprises a second boom head and a boom tip which is fastened to the main boom in a rigid manner or so as to be pivotable about a horizontal pivot axis and comprises a first boom head, wherein the first load suspension means is guided over the first boom head, and the second load suspension means is guided over the second boom head, the first load location is located on the first boom head, and the second load location is located on the second boom head.

11. Method according to claim 1, wherein the first load suspension means is adjustable by means of a first hoisting winch and the second load suspension means is adjustable by means of a second hoisting winch, wherein the hoisting winches are controllable by means of a control unit of the crane.

12. Method according to claim 1, wherein a deviation of the first load suspension means and/or of the second load suspension means from the vertical is acquired and, in the case of an identified deviation, a warning is output and/or a command prompt is displayed and/or a countermeasure is taken automatically by the control unit.

13. Crane comprising a boom, comprising two load suspension means for lifting a joint load or different individual loads, wherein a first load suspension means, adjustable by means of a first hoisting winch, is connected to the boom at a first load location, and a second load suspension means, adjustable by a second hoisting winch, is connected to the boom at a second load location that is spaced apart from the first load location, and comprising a detection device, by means of which a first load introduced into the boom at the first load location, and a second load introduced into the boom at the second load location, can be detected,
the crane further comprising
a control unit which is configured to carry out the steps of the method according to claim 1.

14. Crane according to claim 13, wherein the boom comprises a main boom which is mounted on a carrier device, including a rotatable upper structure, of the crane so as to be pivotable about a horizontal tilt axis and comprises a second boom head and a boom tip which is fastened to the main boom in a rigid manner or so as to be pivotable about a horizontal pivot axis and comprises a first boom head, wherein the first load suspension means is guided over the first boom head, and the second load suspension means is guided over the second boom head, the first load location is located on the first boom head, and the second load location is located on the second boom head.

15. Method according to claim 1, wherein the measure includes outputting a warning and/or intervention in a current movement of the crane by a control unit.

16. Method according to claim 4, wherein the measure includes outputting a warning and/or intervention in a current movement of the crane by the control unit.

17. Method according to claim 5, wherein the first and second forces are acquired via sensors arranged on the first and second guy ropes, and transmitted to the control unit.

18. Method according to claim 6, wherein the measure includes outputting a warning and/or intervention in a current movement of the crane by the control unit.

19. Method according to claim 8, wherein the measure includes outputting a warning and/or intervention in a current movement of the crane by the control unit.

20. A payload monitoring crane system, comprising a boom and two load suspension lattices for lifting one joint load or different individual loads, wherein a first load suspension lattice carries a load which is introduced into the boom at a first load location, wherein a second load suspension lattice carries a load which is introduced into the boom at a second load location that is spaced apart from the first load location, wherein a first load currently introduced into the boom at the first load location, and a second load currently introduced into the boom at the second load location, is detected by a control unit having sensors, the control unit including instructions stored in memory therein, wherein a coordinate system is defined in which along a first axis two mutually spaced points represent the first and second load locations and in which a second axis perpendicular to the first axis represents a load at the respective load location, wherein the following variables are defined:
a first defined correlation between a maximum payload at the first load location and a maximally permissible payload at the second load location in the case of maximum payload utilisation at the first load location,
a second defined correlation between a maximum payload at the second load location and a maximally permissible payload at the first load location in the case of maximum payload utilisation at the second load location, and
a first intersection point, at which the first and second defined correlations are fulfilled simultaneously; wherein the instructions include instructions for determining a third defined correlation between the first load and the second load in the defined coordinate system, a second intersection point, at which the third defined correlation and the first intersection point have the same value along the first axis; and automatically taking a measure if, along the second axis, the value of the second intersection point is greater than the value of the first intersection point.
